(19) United States
(12) Patent Application Publication
(10) Pub. No.: US 2007/0246063 A1
(43) Pub. Date: Oct. 25, 2007

(54) Method of performing a pressure calibration during waferless autoclean process

(75) Inventors: An Chyi Wei, Hsinchu (TW); N. T. Lian, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Macronix International Co., Ltd.

(21) Appl. No.: 11/409,127

(22) Filed: Apr. 21, 2006

(51) Int. Cl. B08B 6/00

(52) U.S. Cl. 134/1.1

(57) ABSTRACT

A method of performing pressure calibration in a chamber during a waterless dry plasma cleaning process is provided, wherein the chamber is used to perform a wafer contact etch. First, the chamber is placed on-line. Next, pressure calibration is performed using a gas. A first waferless dry plasma cleaning process is performed while maintaining pressure stability in the chamber. The wafer contact etch is then performed followed by a second waterless dry plasma cleaning process. The chamber remains on-line during the entire process.

### BACKGROUND OF THE INVENTION

The present invention relates to a pressure calibration method for an on-line chamber system used for the manufacture of semiconductor wafers, and more particularly, to a real-time automatic pressure calibration method for monitoring and controlling the on-line chamber while performing a waferless dry plasma cleaning process used in an etch processing system.

A general contact etch running procedure according to a prior art method is performed as follows:
1. A manual argon gas matrix test is performed for ensuring pressure control stability in a chamber.
2. A first or preliminary waferless dry plasma cleaning process is performed with the chamber in an off-line condition (state). The chamber is prepared for performing a contact etch procedure, but the chamber must be re-connected to the etching system in an on-line condition before performing the contact etch procedure.
3. Once the chamber is in the on-line condition, the contact etch process is performed.
4. After performing the contact etch process, the chamber undergoes a second waferless dry plasma cleaning process. To complete the second dry plasma cleaning process, the chamber again must be removed from the etching system and placed in the off-line condition. Since the general contact etch running procedure must be done in an off-line condition, the general contact etch running procedure is very time consuming and requires additional manpower resources to complete the process.

U.S. Pat. No. 6,860,138 (Hsieh et al.) is directed to a real-time detection of a malfunction for a liquid vaporization system with self-calibrated steps for forming a hardware baseline used in the detection of a pressure change. The self-calibration steps are very complicated and time consuming in order to determine the hardware baseline before completing a film deposition process.

U.S. Pat. No. 6,325,948 (Chen et al.) is directed to a waterless cleaning process of a chamber in a dry etcher system. This process sets the chamber in an off-line condition for performing the cleaning process. By having the chamber in an off-line condition, the manpower requirements increase, thus making this method very time consuming and less efficient. Since the efficiency is lower, this process decreases the overall yield for processing semiconductor wafers.

FIG. 1 is a flow diagram that illustrates a general contact etch running procedure according to a prior art method. The general contact etch procedure starts at step 100 with a manual argon (Ar) gas matrix test for completing a pressure control stability test of the chamber. Argon gas flows into the chamber until a specified pressure is achieved, and then the pressure control stability test is completed to ensure that the pressure is at a desired level. Once step 100 is complete, the procedure continues with step 102 by starting a first or preliminary waterless dry plasma cleaning process. To complete the first waterless dry plasma cleaning process, the chamber is first taken off-line, which is time consuming and requires an operator to complete the process. Afterwards, the chamber is placed back to an on-line condition state and a contact etch process in step 104 is performed. Once the contact etch process is complete, the chamber is removed once again to an off-line condition state and a second waferless dry plasma cleaning process is performed in step 106 in the chamber. The entire process can then be repeated as needed. Since the chamber has to be taken off-line for completing the waterless dry plasma cleaning processes, this process is inefficient with low process yields in a mass production environment.

The purpose of the first and second waferless dry plasma cleaning processes is to clean the internal walls of the chamber by using a cleaning gas formed into a plasma to remove any residue build-up from prior wafer contact etching processes. The clean chamber aids in a more effective contact etch process and reduces excessive wafer scrap due to the residue in the chamber from previous processes.

FIG. 3 is a table that shows an argon gas flow versus pressure specification for a general pressure calibration in accordance with a prior art method when using a manual argon (Ar) matrix test. The table in FIG. 3 illustrates the different argon (Ar) gas flow rates versus the pressure specifications for the off-line chamber. The table shows the settings and ranges for the chamber. Column 1 is a percentage position setting for a confinement ring that is used for controlling the gas flowing into the chamber. Columns 2, 4, 6 and 8 represent the actual pressures (mtorr) in the chamber according to the confinement ring position setting listed in column 1. Columns 3, 5, 7 and 9 define ranges for the pressure specification in the chamber according to the confinement ring positions. For example, row 3 has the confinement ring set to 25 percent position, and column 6 has the argon flow rate set to 600 sccm with a nominal pressure of 71 mtorr. Column 7 shows that the pressure ranges from 65.5 to 72.5 for the chamber at this position setting. If the actual pressure detected in the chamber is within the specification range as defined in the column 7, the chamber is properly calibrated for completing the process. However, if the actual pressure is not within the specification range as listed in column 7, then the calibration procedure must be repeated until the proper pressure is achieved in the chamber before completing any other process. This method requires that the chamber be in an off-line condition, (i.e., not connected to an active system).

FIG. 4 is a table that shows a general waferless dry plasma cleaning procedure recipe for a four step automatic process in accordance with a prior art method. Column 1 identifies the parameters that are set according to the general recipe. Columns 2-5 identify the actual setting for each appropriate step for completing the general recipe. For example, step 3 has the confinement ring set to the mode identified as “position”, which is set at 100 percent and is held in this position for 10 seconds. A 27 MHz RF power source is set to 200 watts with a maximum reflected power at 20 watts, and a 2 MHz RF power source is set to 200 watts with a maximum reflected power at 40 watts. Oxygen (O₂) is used in the chamber for the general recipe, which flows into the chamber at a flow rate of 2,000 sccm. The remaining settings for this step in the recipe are all set to zero. Once step 3 is started, it is performed for a total 30 seconds with the settings shown in FIG. 4. After 30 seconds have elapsed, step 4 is then performed according to the settings listed in column 5 of the table as shown in FIG. 4. Oxygen (O₂) is used with a high flow rate as the cleaning gas for the recipe, which does not have a pressure limitation for the O₂ in the chamber. Therefore, the flow rate of the O₂ is the only parameter that is controlled for the general recipe. This method does not directly detect a pressure instability in the chamber since the chamber is off-line.

### BRIEF SUMMARY OF THE INVENTION

The present invention provides a method of performing pressure calibration in a chamber during a waferless dry plasma cleaning process. The chamber is used to perform a wafer contact etch. The first step in the method is to place the chamber on-line. Next, pressure calibration is performed using a gas. A first waferless dry plasma cleaning process is performed while maintaining pressure stability in the chamber. The wafer contact etch is then performed followed by a second waterless dry plasma cleaning process. The chamber remains on-line during the entire process.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow chart for a general contact etch running procedure according to a prior art method;

FIG. 2 is a flow chart for an improved contact etch running procedure according to one preferred embodiment of the present invention;

FIG. 3 is a table that shows an argon (Ar) flow versus different pressure specifications for a general pressure calibration method of a manual argon (Ar) matrix test according to a prior art method;

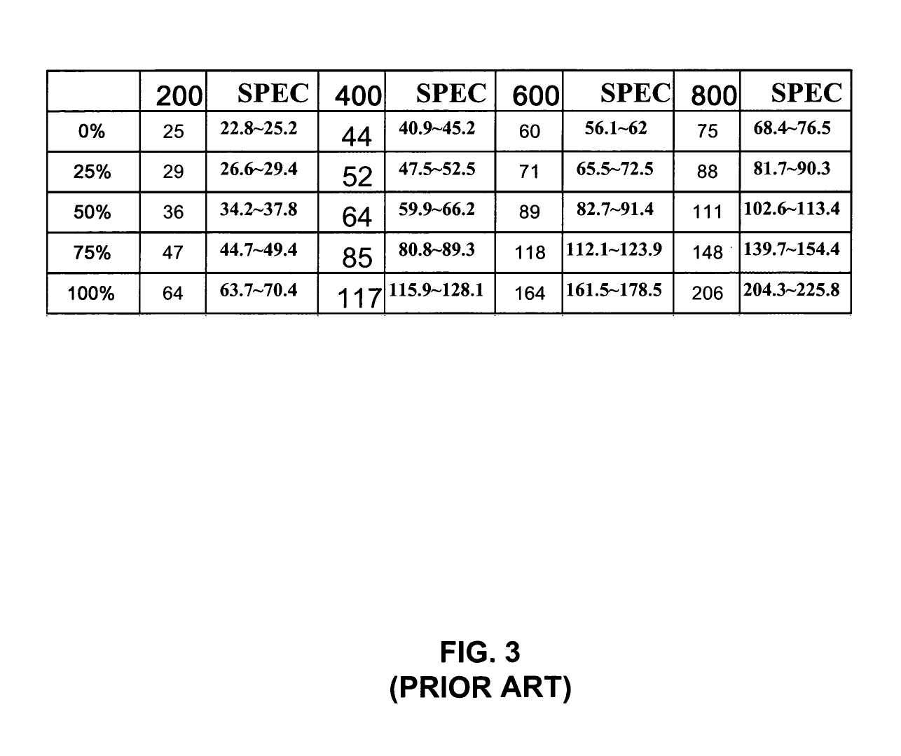

FIG. 4 is a table that shows a general waferless dry plasma cleaning process recipe according to a prior art method; and

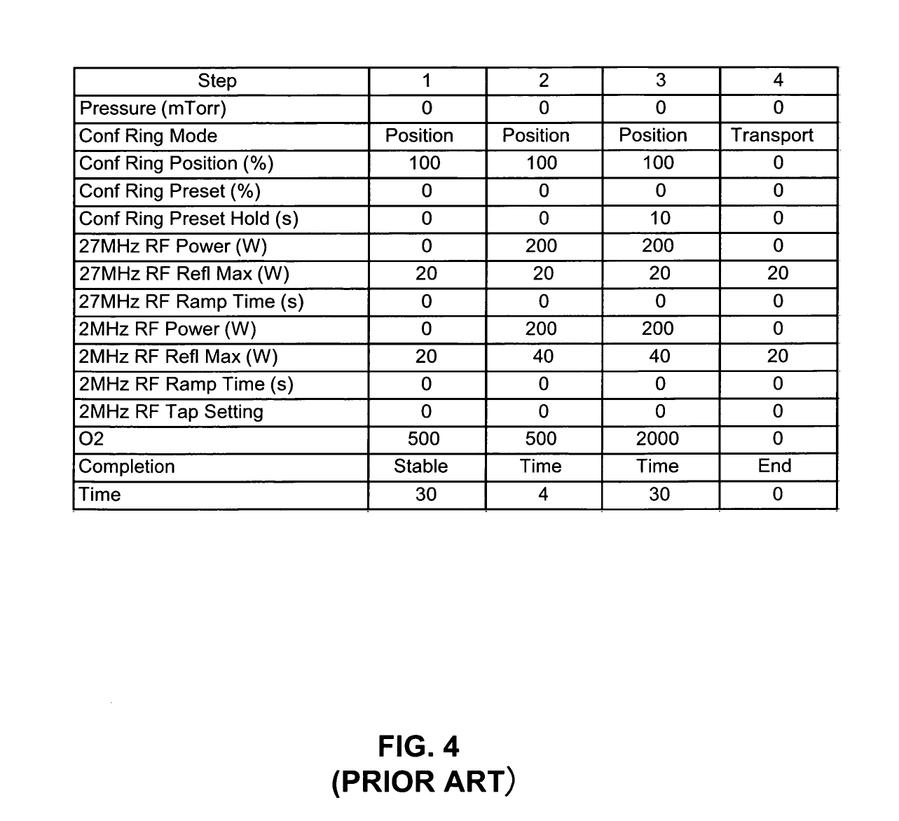

FIG. 5 is a table that shows a modified waterless dry plasma cleaning process recipe that detects and controls a pressure stability according to the present invention.

### DETAILED DESCRIPTION OF THE INVENTION

The present invention allows for pressure calibration of an on-line chamber during a waferless dry plasma cleaning process. If the on-line chamber is not properly cleaned on a regular basis, a build-up of residue can form in the chamber. This residue may cause a pressure instability which can affect the on-line chamber pressure calibration. As the chamber is repeatedly used for wafer etch processing, the residue build up will continue to affect each subsequent etch processes if it is not cleaned before starting the new etch process. This may cause an increase of scrap wafers. During the waferless dry plasma cleaning process, the on-line chamber is monitored for controlling the pressure calibration. Since this can be performed with the chamber in an on-line condition, time is saved and manpower requirements are reduced for performing the full etch process.

One preferred embodiment of the present invention operates as follows:
1. A chamber is placed in an on-line condition and then pressure calibration is performed using a gas for the on-line chamber. One preferred gas used is argon.
2. Pressure stability is maintained in the on-line chamber while performing a first waferless dry plasma cleaning process (referred to as a “Pre-WAC” process).
3. A wafer contact etch procedure is then performed.
4. Once the contact etch procedure is complete, a second waterless dry plasma cleaning process (referred to as a “WAC” process) is performed. The chamber remains on-line while performing each step. The contact etch procedure and the second waterless dry plasma cleaning process is iteratively repeated for a predetermined number of times for the on-line chamber.

The pressure calibration is automatically performed before every first waferless dry plasma cleaning process. In addition, maintaining the pressure stability in the on-line chamber controls the wafer contact etch process window, which improves a gain yield over many iterative processes. The pressure instability can be detected in advance before performing the first dry waterless dry etch plasma cleaning process. By detecting the pressure instability in advance, wafer scrap hazard is decreased. The pressure stability is automatically maintained by at least one pressure servo that is operated between a soft tolerance and a hard tolerance for the pressure, which has their values set according to a process recipe. This method can be used for the chamber while it remains in the on-line state and applied to any pressure range for the chamber. However, the preferred on-line chamber pressure range is from about 50 mtorr to about 70 mtorr.

One preferred method of performing the pressure calibration during the waterless dry etch cleaning process provides a modified software function for the etching system. The modified software function includes an alarm for displaying an alarm message according to the condition of the on-line chamber. For example, the modified software function provides the alarm message when a plasma fails to form in the on-line chamber.

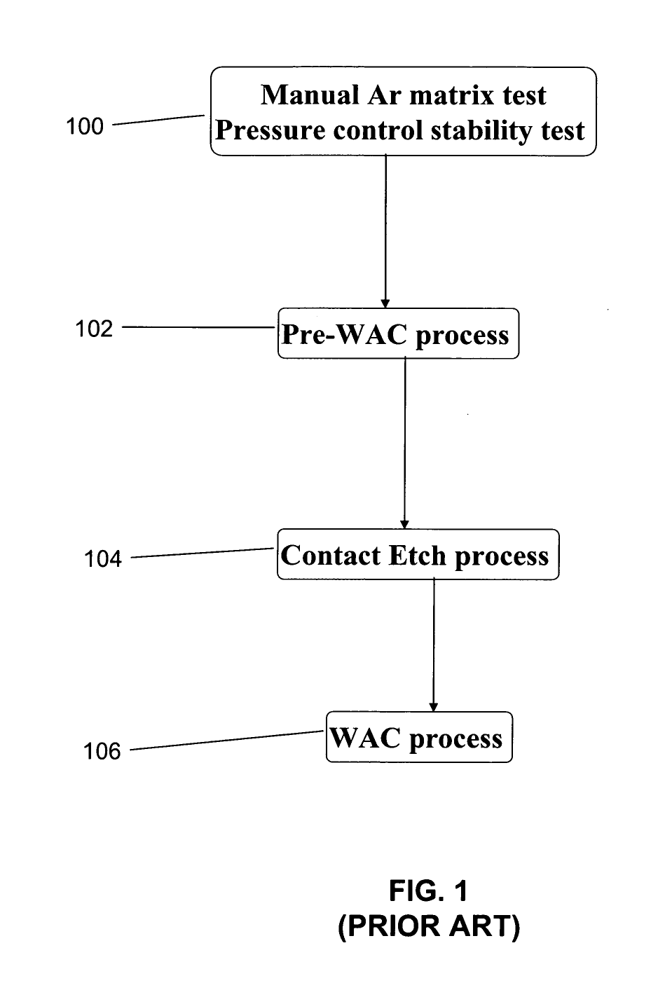

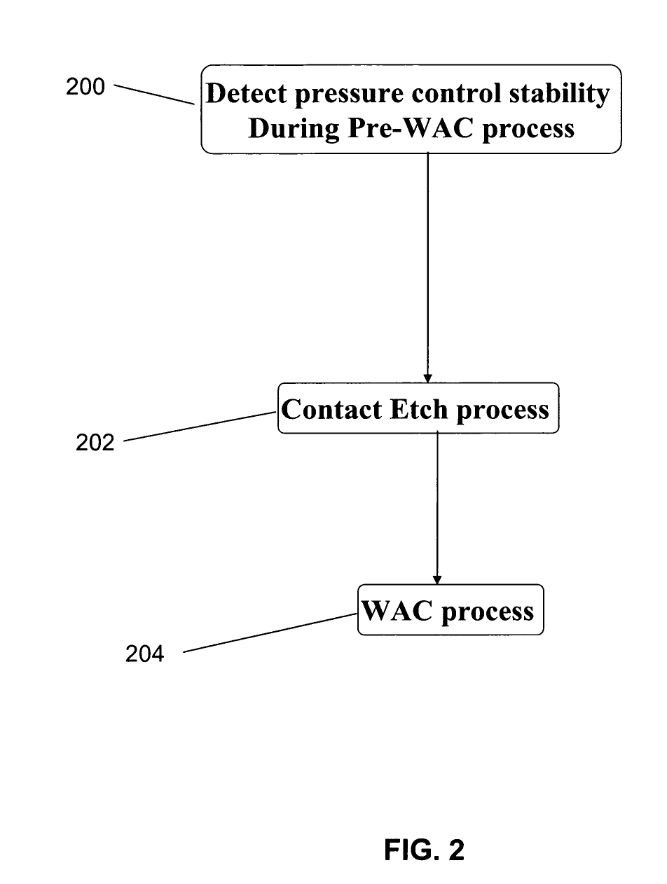

FIG. 2 is a flow diagram of a contact etch running procedure in accordance with the present invention. The procedure starts with step 200 wherein pressure control stability is detected during a first or preliminary waterless dry plasma cleaning process. One advantage of this step over the prior art method shown in FIG. 1 is that the chamber is not removed from the system and remains in an on-line condition state. During step 200, the pressure control stability is automatically monitored and maintained in the on-line chamber while the first waterless dry plasma process is being performed. Next, a contact etch process is performed (step 202). A second waterless dry plasma cleaning process is then performed in the chamber (step 204) while maintaining the chamber in the on-line condition. Each of the waterless dry plasma cleaning processes is performed to clean the internal walls of the chamber by providing a cleaning gas, such as argon, which is generated into the plasma for removing any residue that has formed from the prior wafer contact etching procedure.

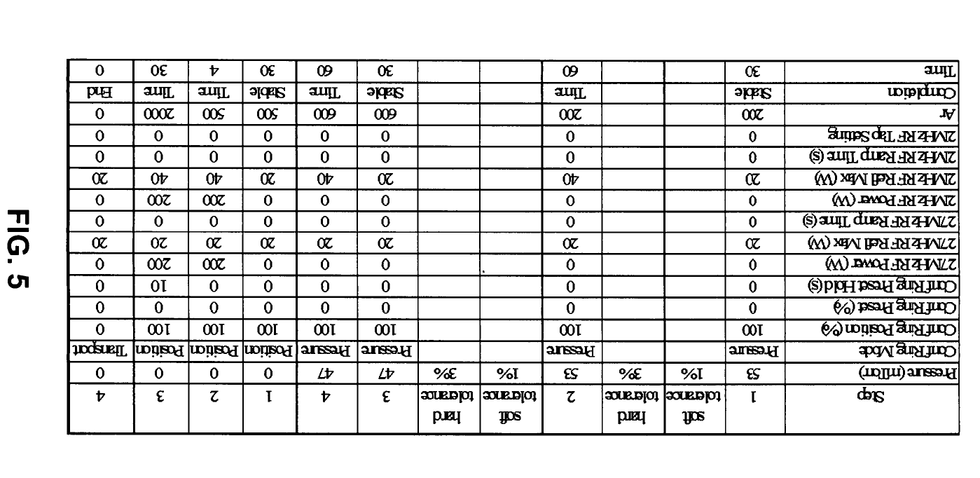

FIG. 5 is a table that shows a modified process recipe for completing the waferless dry plasma cleaning, and which is used for detecting the pressure control stability in the on-line chamber in accordance with the present invention. Column 1 identifies the parameters that are set according to the modified waferless dry plasma cleaning process recipe. Columns 2, 5, 8-13 show the actual settings for the appropriate steps in the modified recipe. Columns 3 and 6 show the soft tolerances for the pressure (mtorr) in the chamber, which are set as required for each process that is performed. If the actual pressure is out of the soft tolerance range, the modified software function and the system alarm displays an alarm warning message. Columns 4 and 7 identify the hard tolerances for the pressure (mtorr) in the chamber, which are set as required for each process. If the actual pressure is out of the hard tolerance range, the modified software function and the system alarm will display the alarm warning message and stop the process by shutting down the system. The pressure stability in the on-line chamber is maintained by controlling the pressure servo according to the soft and hard tolerance ranges set in the modified process recipe. For the modified process recipe, the auto pressure calibration is completed before every first waferless dry plasma cleaning process.

The modified software function, including the system alarm, always monitors the on-line chamber and displays the alarm message when the plasma is not present or detected in the chamber. The modified software function requires no hardware retrofit for present commercial systems. The modified software function only requires installation onto the commercial systems for implementing the method of the present invention.

Some advantages of the present invention include the ability to detect the pressure instability or stability of the on-line chamber in advance while performing the first waterless dry plasma cleaning process, the second waferless dry plasma cleaning process, and the contact etch process. The etch recipe is sensitive to the on-line chamber pressure variation, which is easy to maintain with the modified software function. Additionally, since this is a waferless dry plasma cleaning process, monitor wafers are not needed to complete the pressure calibration of the on-line chamber while performing the process, thereby reducing excessive wafer scrap hazard. Therefore, time and manpower requirements are saved during each of the processes in a mass production environment.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of performing a pressure calibration in a chamber during a waferless dry plasma cleaning process, the chamber being used to perform a wafer contact etch, the method comprising:
(a) placing the chamber on-line;
(b) performing the pressure calibration using a gas;
(c) performing a first waferless dry plasma cleaning process while maintaining pressure stability in the chamber;
(d) performing the wafer contact etch; and
(e) performing a second waferless dry plasma cleaning process,
wherein the chamber remains on-line during steps (b) to (e).

2. The method of claim 1 further comprising:
(f) iteratively performing steps (d)-(e) for a predetermined number of times.

3. The method of claim 1 further wherein step (b) is automatically performed before every first waferless dry plasma cleaning process.

4. The method of claim 1 further wherein step (c) further detects any pressure instability before performing the first waferless dry etch plasma cleaning process.

5. The method of claim 1 wherein the pressure stability is automatically maintained by at least one pressure servo that is operated between a soft tolerance and a hard tolerance for the pressure, the soft and hard tolerances both being set according to a process recipe.

6. The method of claim 1 wherein the pressure in the on-line chamber is about 50 mtorr to about 70 mtorr.

7. The method of claim 1 wherein the gas is argon gas.
